(19) United States
(12) Patent Application Publication
(10) Pub. No.: US 2026/0018972 A1
(43) Pub. Date: Jan. 15, 2026

(54) Package Integration of a Rotor Position Sensor in a Rotary Transformer

(71) Applicants: BorgWarner Inc., Auburn Hills, MI (US); UT-Battelle, LLC, Oak Ridge, TN (US)

(72) Inventors: Gabriel Alejandro Domingues Olavarria, Lund (SE); Fred Huscher, Hendersonville, NC (US); Mostak Mohamamd, Knoxville, TN (US); Shajjad Chowdhury, Knoxville, TN (US); Omer Onar, Farragut, TN (US); Jonathan Wilkins, Knoxville, TN (US); Matthew Conner, Franklin, IN (US); Eric Strauss, Fort Collins, CO (US); Kirk Neet, Noblesville, IN (US)

(21) Appl. No.: 19/269,211

(22) Filed: Jul. 15, 2025

Related U.S. Application Data
(60) Provisional application No. 63/671,589, filed on Jul. 15, 2024.

(51) Int. Cl. H02K 11/20; G01D 5/20; H02K 1/12; H02K 1/22

(52) U.S. Cl. CPC H02K 11/20; G01D 5/204; H02K 1/12; H02K 1/22

(57) ABSTRACT

A rotary transformer is disclosed herein comprising a stationary portion and a rotating portion. The stationary portion includes a transformer housing, a primary coil positioned within the transformer housing and defining a central axis, and a stationary printed circuit board (PCB). The stationary PCB includes an excitation coil of an inductive position sensor and at least one sensing coil of the inductive position sensor. The rotating portion of the rotary transformer includes a rotating PCB with a secondary coil of the rotary transformer positioned on the rotating PCB. The rotating portion further includes a diode holder connected to the rotating PCB. The diode holder includes at least one target for the inductive position sensor.

### CROSS-REFERENCE TO RELATED APPLICATIONS

This application claims priority to U.S. Provisional Patent Application No. 63/671,589, filed Jul. 15, 2024, the entire contents of which are incorporated herein by reference.

### STATEMENT OF GOVERNMENT RIGHTS TO PATENT

This invention was made under CRADA No. NFE-22-09369 between BorgWarner Inc. and UT-Battelle, LLC, management and operating contractor for the Oak Ridge National Laboratory for the United States Department of Energy. The Government has certain rights in this invention.

### FIELD

The present disclosure relates to the field of electric machines, and particularly to rotary transformers used in electric machines.

### BACKGROUND

Wound rotor synchronous machines (WRSMs) are increasingly common in many modern applications, including electric vehicles, wind turbines and industrial motors. WRSMs do not use any permanent magnets (PM) and are great alternatives to permanent magnet based motors for many applications. However, traditional WRSMs have disadvantages because they use brushes and slip rings for power transfer between the stator and the rotor. These brushes and slip rings cause friction, wear, and frequent maintenance.

Polyphase rotary transformers have been utilized in various applications to enable wireless power transfer to the rotor windings of WRSMs. Rotary transformers are particularly advantageous because they eliminate the need for slip rings and brushes. By using a high-frequency, three-phase rotary transformer in WRSMs, the challenges associated with slip rings and brushes are avoided.

The rotary transformer is especially applicable for high-speed and high-frequency applications, such as electric vehicles (EVs). In many applications for WRSMs, there are numerous rotating members that need to be monitored. For example, in vehicles, various rotating members transfer power to the wheels of the vehicle and monitoring of these rotating members is important in order to control functions of the vehicle. Rotary sensors are commonly used in vehicles to monitor these rotating members.

In view of the foregoing, it would be advantageous to provide an arrangement wherein a rotary position sensor could be advantageously used alongside a rotary transformer. It would be particularly advantageous if such a rotary transformer and rotary position sensor offered a compact design with smaller and more efficient components. A compact design would be especially advantageous in motor vehicle applications and related applications with limited space. Moreover, it would be advantageous if the rotary transformer and rotary position sensor were offered in arrangement that resulted in lower manufacturing costs and improved manufacturing efficiencies for the desired application.

### SUMMARY

A system and method is disclosed herein for package integration of an inductive position sensor into the assembly of a rotary transformer used to feed the rotor of a wound rotor synchronous machine (WRSM). In the embodiments disclosed herein, a stationary printed circuit board (PCB) is provided with the transmitter, sensing coils and position sensor circuitry in the external face of the rotary transformer housing. A diode holder is utilized as the targets for the position sensor.

In at least one embodiment disclosed herein a rotary transformer comprises a stationary portion and a rotating portion. The stationary portion includes a transformer housing, a primary coil positioned within the transformer housing and defining a central axis, and a stationary printed circuit board (PCB). The stationary printed circuit board includes an excitation coil of an inductive position sensor and at least one sensing coil of the inductive position sensor. The rotating portion of the rotary transformer includes a rotating PCB with a secondary coil of the rotary transformer positioned on the rotating PCB. The rotating portion further includes a diode holder connected to the rotating PCB. The diode holder includes at least one target for the inductive position sensor.

In at least one additional embodiment, disclosed herein a rotary transformer comprises a stationary portion including a transformer housing with a core arranged within the transformer housing and a primary coil arranged within the core. The stationary portion of the rotary transformer further includes an excitation coil of an inductive position sensor and at least one sensing coil of the inductive position sensor arranged on a stationary mount, such as a first printed circuit board. The rotary transformer further comprises a rotating portion including a diode holder connected to a rotating coil mount, such as a second printed circuit board. A secondary coil of the rotary transformer is arranged on the rotating coil mount and positioned within the core. At least one target of the inductive position sensor is positioned on the diode holder.

In at least one further embodiment disclosed herein, a wound rotor synchronous machine (WRSM) comprises a stator, a rotor, and a rotary transformer. The stator includes a stator core with stator windings positioned on the stator core. The rotor is positioned within the stator and includes a rotor core with rotor windings positioned on the rotor core. A rotor coupling is connected to the rotor. The rotary transformer includes a stationary portion and a rotating portion. The stationary portion of the rotary transformer includes a primary coil, an excitation coil of an inductive position sensor, and at least one sensing coil of the inductive position sensor. The rotating portion of the rotary transformer is connected to the rotor coupling. The rotating portion includes a diode holder connected to a rotating coil mount. The diode holder includes at least one target of the inductive position sensor. A secondary coil is arranged on the rotating coil mount.

The above described features and advantages, as well as others, will become more readily apparent to those of ordinary skill in the art with reference to the following detailed description and accompanying drawings. While it would be desirable to provide a method and system for package integration of a rotor position sensor in a rotary transformer that provides one or more of the advantageous features as may be apparent to those reviewing this disclosure, the teachings disclosed herein extend to those embodiments which fall within the scope of any eventually appended claims, regardless of whether they include or accomplish one or more of the advantages or features mentioned herein.

### BRIEF DESCRIPTION OF THE DRAWINGS

FIG. 1 shows a perspective cutaway view of a rotary transformer package with an integrated position sensor for an electric motor;

FIG. 2 shows a second perspective cutaway view of the rotary transformer package of FIG. 1;

FIG. 3 shows a side cutaway view of the rotary transformer package of FIG. 1;

FIG. 4 shows a perspective view of the rotary transformer package of FIG. 1;

FIG. 5 shows a perspective view of a diode holder of the rotary transformer of FIG. 1 in isolation from other components of the rotary transformer, the diode holder including targets for the position sensor;

FIG. 6 shows a first perspective view of the position sensor in isolation from other components of the rotary transformer package of FIG. 1, the position sensor including a printed circuit board with excitation and sensing coils positioned across an airgap from the diode holder of FIG. 5;

FIG. 7 shows a second perspective view of the position sensor of FIG. 6;

FIG. 8 shows a perspective cutaway view of the position sensor of FIG. 6;

FIG. 9 shows a perspective view of rotating components of the rotary transformer package of FIG. 1 including the diode holder connected to a secondary coil of the rotary transformer;

FIG. 10 shows a perspective cutaway view of the rotating components of FIG. 9;

FIG. 11 shows a side cutaway views of the rotating components of FIG. 10; and

FIG. 12 shows a schematic diagram of the rotary transformer arrangement with the integrated rotary position sensor of FIG. 1 integrated into a wound rotor synchronous machine.

### DESCRIPTION

A rotary transformer package is disclosed herein comprising a housing, a ferrite core, a primary coil, a secondary coil, a diode rectifier, and a holder for the diode rectifier. The rotary transformer advantageously utilizes the housing and holder for the diode rectifier in order to integrate an inductive position sensor into the rotary transformer package. The disclosed arrangement includes stationary printed circuit board (PCB) with a sensing coil for the position sensor on a stationary portion of the rotary transformer. The sensing coil is positioned in one of the transformer's external walls separated by an insulating layer. Furthermore, on the rotating portion of the transformer, the holder of the diode rectifier is configured with features that allow it to fulfill the additional function of providing the targets for the position sensor.

In the following detailed description, reference is made to the accompanying figures which form a part hereof wherein like numerals designate like parts throughout, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense, and the scope of embodiments is defined by the appended claims and their equivalents.

Aspects of the disclosure are disclosed in the accompanying description. Alternate embodiments of the present disclosure and their equivalents may be devised without parting from the spirit or scope of the present disclosure. It should be noted that any discussion herein regarding “one embodiment”, “an embodiment”, “an exemplary embodiment”, and the like indicate that the embodiment described may include a particular feature, structure, or characteristic, and that such particular feature, structure, or characteristic may not necessarily be included in every embodiment. In addition, references to the foregoing do not necessarily comprise a reference to the same embodiment. Further, irrespective of whether it is explicitly described, one of ordinary skill in the art will readily appreciate that each of the particular features, structures, or characteristics of the given embodiments may be utilized in connection or combination with those of any other embodiment discussed herein.

Additionally, it will be noted that the following description of embodiments of the rotary transformer makes use of relative terms that may be dependent on an orientation of the structure at a given time (e.g., during manufacture or use of the machine in a vehicle). Accordingly, it will be recognized that many terms of orientation and position as used herein are defined with reference to what may be shown in the drawings and/or other common positions. While efforts have been made herein to reference portions of a structure with respect to non-changing features (e.g., “axial,” “radial” and “circumferential” directions and related positions of the stator), it will be recognized that other terms are relative terms that depend on the position of the structure.

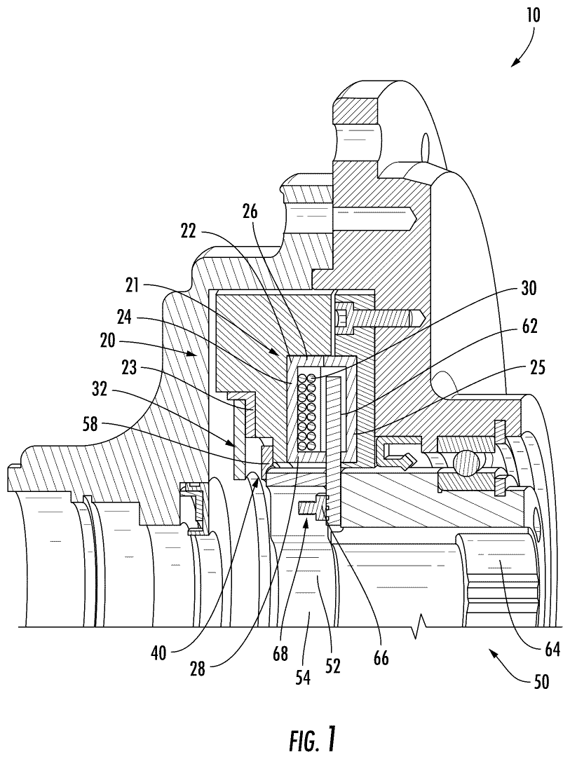

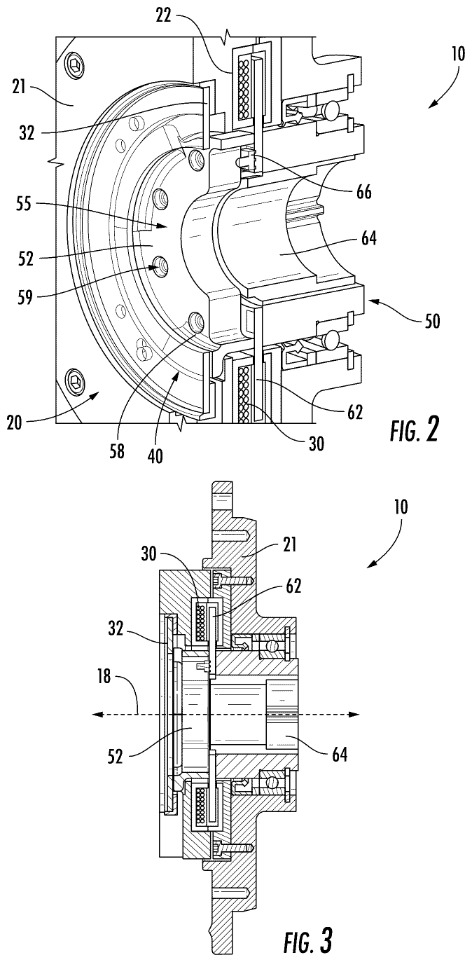

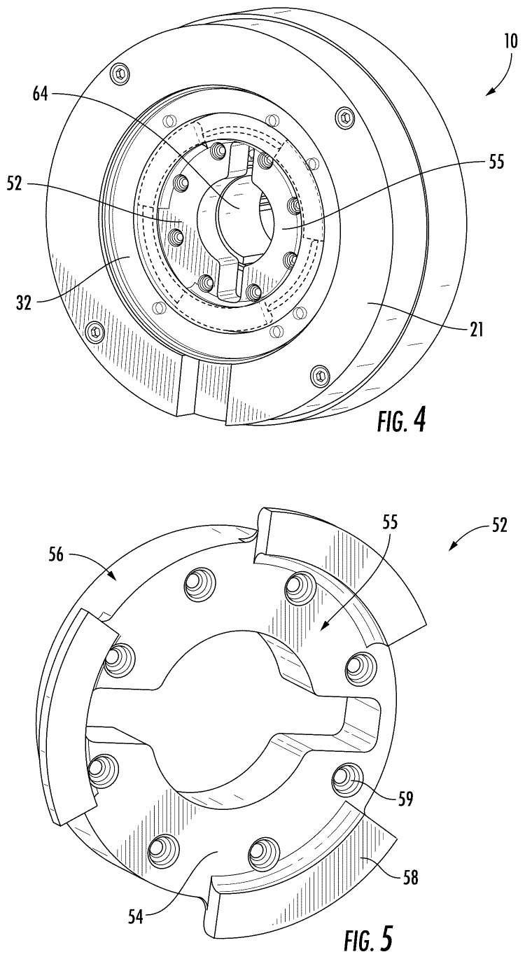

With particular reference now to FIGS. 1-4, a rotary transformer 10 is shown. The rotary transformer 10 includes a stationary portion 20 with a primary coil 30 and a rotating portion 50 with a secondary coil 60. An inductive rotary position sensor 40 is also included on the rotary transformer 10. The inductive rotary position sensor 40 includes an excitation coil 42 and sensing coils 44 on the stationary portion 20, and at least one target 58 arranged on a diode holder 52 included on the rotating portion 50.

The stationary portion 20 of the rotary transformer 10 includes a housing 21, a core 22, a primary coil 30, a stationary printed circuit board 32, and coils of the rotary position sensor 40. The housing 21 provides a solid structure configured to support and retain the various components on the stationary portion of the rotary transformer. The housing 21 is comprised of a material that is generally lightweight, rigid, and strong. For example, the housing may be comprised of aluminum, a strong polymer material, or any other appropriate material for a rotary transformer housing, as will be recognized by those of ordinary skill in the art.

The core 22 is retained within the housing 21. The core 22 is comprised of ferrite or other magnetic-permeable material. The core 22 has a generally circular/cylindrical shape formed around a central axis 18. The core includes a first disc-shaped face 24, a second disc-shaped face 25, a cylindrical outer wall 26 and a cylindrical inner lip 28. The first face 24 extends in a radial direction on one axial side of the core 22. The second face 25 extends in a radial direction on an opposite axial side of the core 22. The cylindrical outer wall extends in the axial direction between the first face 24 and the second face 25. The cylindrical inner lip 28 extends in an axial direction from the first face 24 toward the second face 25. Because the cylindrical inner lip 28 does not extend completely to the second face 25, a circular opening to an interior cavity of the core is provided between an end of the cylindrical inner lip 28 and the second face 25. The interior cavity of the core 22 is circular cavity defined within the confines of the first face 24, second face 25, cylindrical outer wall 26, and cylindrical inner lip 28.

The primary coil 30 is positioned within the circular interior cavity defined by the core 22. The primary coil 30 is comprised of a plurality of turns of wire or other conductors wound in a circular manner around the inner lip 28, concentric with the central axis 18. In at least one embodiment, the wire used to form the primary coil 30 may be Litz wire. As will be recognized by those of ordinary skill in the art, Litz wire includes a number of individually insulated magnet wires twisted or braided into a uniform pattern. Litz wire may be used to advantageously reduce field resistance and allows electric currents to flow more freely within the primary coil.

The stationary printed circuit board 32 (PCB) is also positioned within the housing 21, outside of the core 22 (i.e., separated from the core). In the embodiment disclosed herein, the stationary PCB 32 is arranged axially outward from the primary coil 30, positioned in an external wall of the transformer housing 21, and separated from the core 22 and primary coil 30 by an insulating layer 23. An outer portion of the stationary PCB 32 is overlapping the core 22 and the primary coil 30 in the radial direction (i.e., the outer perimeter of the stationary PCB is a same distance from the center axis 18 as at least some points of the core 22 and primary coil 30). An inner portion of the stationary PCB 32 is closer to the central axis 18 in the radial direction than the inner lip 28 of the core 22. The stationary PCB 32 is comprised of a non-conductive substrate with a plurality of conductive pathways formed thereon, as will be recognized by those of ordinary skill in the art. The substrate may be any of a number of different materials that are relatively lightweight and durable while also providing mechanical support and electrical insulation. For example, in at least some embodiments the stationary PCB may be comprised of a fiberglass. The conductive pathways on the PCB may be formed from copper or any other appropriate conductive material.

The coils of the inductive rotary position sensor 40 are positioned on the stationary PCB 32. These coils include an excitation coil 42 and at least one sensing coil 44 (and typically two sensing coils 44). The coils 42 and 44 are specifically configured as conductive traces on the PCB 32. These conductive traces are not illustrated in detail in the figures (other than being illustrated in FIG. 6 by short curve segments for the sake of simplicity), but it will be noted that the conductive traces formed on the stationary PCB 32 form complete coils for the rotary position sensor 40, including the complete excitation coil 42 and the complete sensing coils 44. As will be recognized by those of ordinary skill in the art, the excitation coil 42 of the inductive rotary sensor 40 is used to generate an AC magnetic field. This magnetic field couples onto the sensing coils 44. When a target of the sensor (e.g., the radial tabs 58 of the diode holder 52, discussed in further detail below) disturbs the generated magnetic field, the sensing coils 44 receive different voltages. The different voltages received by the sensing coils 44 may be used to determine a position of a rotating member upon which the target is placed (e.g., the rotating portion 50 of the rotary transformer 10). In at least one embodiment a ratio of a voltages between a first sensing coil and a second sensing coil is used to determine an angular position of the target on rotating portion 50 of the rotary transformer 10.

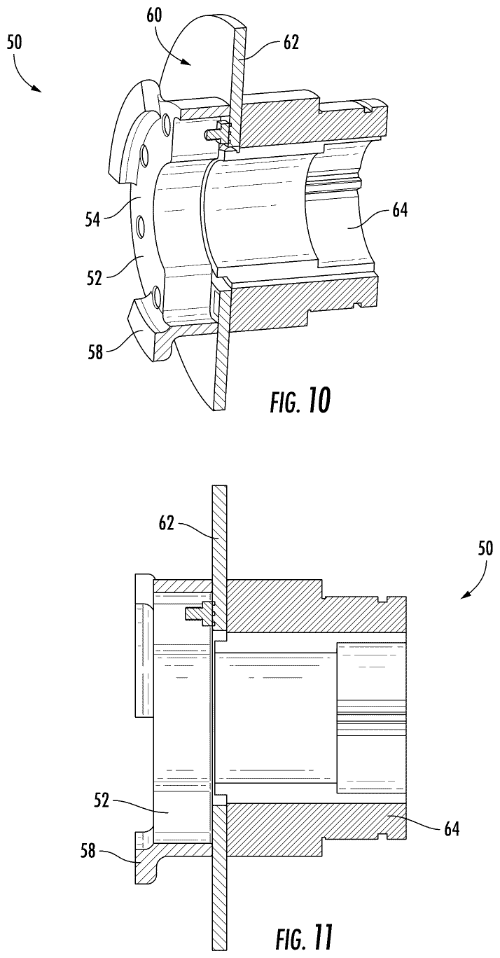

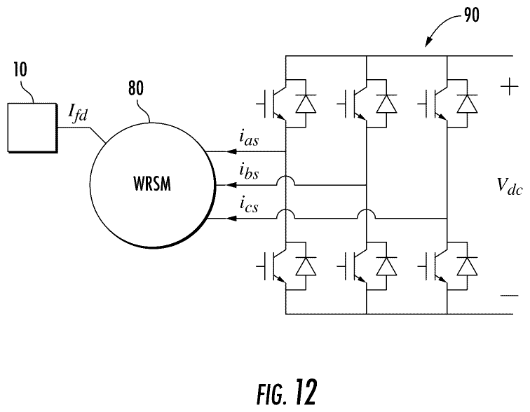

With continued reference to FIGS. 1-4 and additional reference to FIGS. 9-11, the rotating portion 50 of the rotary transformer 10 includes a rotating diode holder 52 and a secondary coil 60 arranged on a rotating PCB 62. The rotating portion 50 of the rotary transformer 10 is coaxial with the stationary portion 20 and configured to rotate about the central axis 18. It will be recognized that the term “rotating” as used herein refers to a component that is configured to rotate when the rotary transformer 10 is in use. The word “rotating” does not refer to a component that is presently rotating and/or must be experiencing rotational movement in order for the component to be considered a “rotating” component. For example, the rotating diode holder 52 is still considered to be a “rotating diode holder” by virtue of being configured to rotate when the rotary transformer 10 is in use and remains a “rotating diode holder” when the rotary transformer 10 is not in use and the diode holder 52 is not rotating.

The rotating diode holder 52 includes a cylindrical main body 54 with a plurality of protrusions in the form of radial tabs 58 extending radially outward from the main body 54. The diode holder 52 is arranged in the rotary transformer 10 such that it is radially inward from the primary coil 30 and axially adjacent to (i.e., at a same radial position as) the stationary PCB 32. More specifically, the main body 54 of the diode holder 52 is closer to the center axis 18 than the primary coil 30, and the tabs 58 of the diode holder 52 are at a same radial distance as the sensing coils 44 from the center axis 18. The material used to form the diode holder 52 may be any of various materials as will be recognized by those of ordinary skill in the art as being appropriate for mounting the diodes 66 and offering heat dissipation for cooling the diodes during operation of the rotary transformer 10. For example, in at least one embodiment, the diode holder 52 is comprised of copper or other heat conducting material.

As best shown in FIG. 5, the main body 54 of the diode holder 52 is cylindrical in shape and includes opposing axial faces 55 and 57 with a circumferential outer surface 56 extending between the opposing axial faces 55, 57. Mounting bores 59 extend through the main body 54 from one axial face 55 to the other 57. The mounting bores 59 are configured to receive bolts used to secure the diode holder to the rotating PCB 62 and a rotor coupling 64. The rotor coupling 64 is configured to connect the rotating portion 50 of the rotary transformer to the rotor (e.g., via the rotor shaft). The rotating PCB 62 is connected to the proximal one of the two opposing axial faces 55, 57. The tabs 58 of the diode holder 52 are arranged on the distal one of the two opposing axial faces 55 (i.e., the face 55 that is closest to the stationary PCB 32 and farthest from the rotating PCB 62).

The tabs 58 of diode holder 52 are relatively flat disc segments that project radially outward from the associated axial face 55 and extend a limited circumferential distance around the axial face. As best shown in FIG. 5, a radially inward perimeter portion of each tab is connected to the face 55 of the main body 54 of the diode holder 52. A radially outward perimeter portion of each tab 58 defines a free circumferential edge that is not connected to any other component. The number of tabs 58 on the diode holder 52 matches the number of pole pairs of the WRSM. Each tab 58 covers an angular span of 360° divided by the number of poles of the WRSM, and the tabs 58 are separated from each other by an empty space of equal angular span. As noted previously, this design allows the tabs 58 to act as the targets of the inductive position sensor 40 (which targets provided by the tabs 58 may also be referred to herein as “target tabs” or simply “targets”). Accordingly, the tabs 58 are comprised of electrically conductive material, such as copper. The tabs 58 may be integrally formed with the main body 54 of the diode holder 52 or may be individual pieces that are attached to the main body 54 by different means (e.g., using fasteners and/or adhesives).

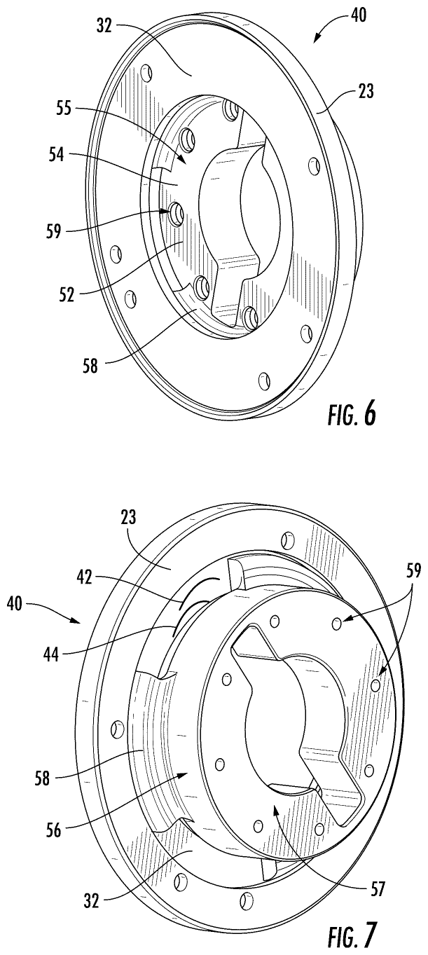

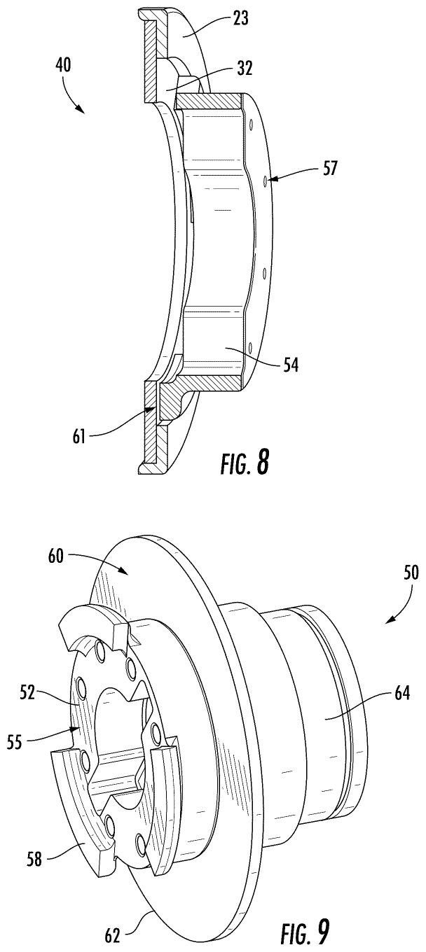

Together, the rotating target tabs 58 on the rotating portion 50 of the rotary transformer 10 along with the excitation coil and sensing coils 44 on the stationary PCB 32 provide the rotary position sensor 40. The components of the rotary position sensor 40 are shown in isolation in FIGS. 6-8. As best shown in FIG. 8, the target tabs 58 on the diode holder 52 are positioned across a small airgap 51 from the sensing coils 44 on the stationary PCB. As noted previously, the voltages sensed by the sensing coils 44 are used to determine an angular position of the target on components connected to the rotating portion 50 of the rotary transformer 10.

As noted previously, a plurality of diodes 66 are mounted on the diode holder 52. In the embodiment disclosed herein, the plurality of diodes 66 are embedded in recesses 68 formed in the main body of the diode holder 52. The diodes are electrically connected to form a diode bridge that rectifies the alternating current in the secondary coil into direct current (e.g., for delivery to rotor coils of a WRSM), as will be recognized by those of ordinary skill in the art. For example, the diode rectifier may include four diodes 66 that are equally spaced apart on the diode holder 52 and embedded in recesses 68 on a face 57 of the diode holder 52 adjacent the rotating PCB 62 (e.g., each diode is positioned 450 offset on the PCB relative to its neighbor diodes with leads to the diodes extending toward the rotating PCB 62).

In addition to the above, the rotating portion 50 of the rotary transformer 10 further includes a secondary coil 60 arranged on the rotating PCB 62, wherein the rotating PCB 62 provides a monolithic mount for the secondary coil 60. The rotating PCB 62 extends radially outward from the diode holder 52 on the rotary transformer 10, through the opening to the core 22, and into the cavity of the core 22. The rotating PCB 62 is comprised of a non-conductive substrate with a plurality of conductive pathways formed thereon. Similar to the stationary PCB 32, the substrate of the rotating PCB 62 may be any of a number of different materials that are relatively lightweight and durable while also providing mechanical support and electrical insulation. The conductive pathways on the rotating PCB 62 may be formed from copper or any other appropriate conductive material.

The secondary coil 60 of the rotary transformer 10 is comprised of a plurality of turns of conductive traces that are arranged a circular manner around the central axis 18 on the PCB 62. The secondary coil 60 is arranged on the PCB 62 such that it is directly across from (i.e., axially adjacent to) the primary coil 30 within the core 22 of the stationary portion 20 of the rotary transformer 10. As noted previously, the secondary coil 60 is further connected to the diodes 66 of the diode rectifier via traces leading from the secondary coil 60 to the diodes 66 (which diodes 66 are connected to the rotating PCB 62). During operation of the transformer, a magnetic field from the primary coil 30 links with the secondary coil 60 and induces an alternating current in the secondary coil 60 as the secondary coil 60 rotates. The alternating current induced in the secondary coil 60 is rectified using the diode rectifier provided by the diodes 66.

In at least some applications, embodiments of the rotary transformer disclosed herein are used in association with electric machines, such as WRSMs used in electric vehicles. An example of such an arrangement wherein the rotary transformer is used in association with a WRSM is illustrated in FIG. 12. The WRSM 80 includes a stator with armature windings and a rotor with field windings, as will be recognized by those of ordinary skill in the art. An example of such a WRSM is disclosed in US Patent Publication No. 2023/0344321, assigned to BorgWarner, Inc. of Auburn Hills, Michigan, the entire contents of which are incorporated by reference herein. The stator windings are configured to receive three phase alternating current from an electrical power source Vdc. For example, in a motor vehicle application, the electrical power source is a vehicle battery The electrical power source is connected to an inverter 90 which converts DC power from the battery to three phase alternating current (iₐₛ, i_{bs}, i_{cs} in FIG. 12) flowing through the windings of the stator. This three phase current is also delivered to the primary coil 30 of the rotary transformer 10. The alternating current in the primary coil 30 of the rotary transformer results in a constantly changing magnetic field around the primary coil 30. This magnetic field then links with the secondary coil 60, inducing an alternating current in the secondary coil 60. The alternating current in the secondary coil 60 is rectified via diodes 66 of the rectifier and delivered as direct current (I_{fd} in FIG. 12) to the field windings of the rotor. The field windings establish magnetic poles on the rotor that then follow the alternating current in the armature windings, causing the rotor to rotate during operation of the WRSM 80.

During operation of the WRSM 80, the inductive rotary sensor 40 integrated into the rotary transformer 10 may be used to sense the position of the rotor (or other rotating components of the electric machine). The inductive position sensor 40 uses the physical principles of induction in a wire loop and Eddy currents to detect the position of the metallic targets/tabs 58 that are rotating adjacent the set of sensor coils provided by the excitation coil 42 and two sensing coils 44. As noted previously, in the embodiments disclosed herein these three coils are printed as copper traces on the stationary printed circuit board 32. They are arranged such that the transmitter coil induces a secondary voltage in the receiver coils which depends on the position of the metallic targets/tabs 58 adjacent to the coils 42, 44. After demodulating and processing the secondary voltages from the sensing coils 44, a signal representative of the metallic target's position over the coils is obtained. For example, a ratio of voltages between two sensing coils 44 may be used to determine an angular position of the target on rotating portion 50 of the rotary transformer 10.

Although an embodiment of package integration for a rotor position sensor in a rotary transformer has been provided herein, it will be appreciated by those of skill in the art that other implementations and adaptations are possible. Furthermore, aspects of the various embodiments described herein may be combined or substituted with aspects from other features to arrive at different embodiments from those described herein. Thus, it will be appreciated that various of the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by any eventually appended claims.

What is claimed is:

1. A rotary transformer comprising:
a stationary portion including:
a transformer housing;
a primary coil of the rotary transformer positioned within the transformer housing and defining a central axis; and
an inductive position sensor including an excitation coil and at least one sensing coil; and
a rotating portion including:
a secondary coil of the rotary transformer; and
a diode holder including at least one target for the inductive position sensor.

2. The rotary transformer of claim 1 wherein the excitation coil of the inductive position sensor is printed on a stationary printed circuit board (PCB).

3. The rotary transformer of claim 2 wherein the secondary coil of the rotary transformer is printed on a rotating PCB, and wherein the diode holder is connected to the rotating PCB.

4. The rotary transformer of claim 3 wherein the stationary portion further includes a core defining a cavity, wherein the core is positioned in the transformer housing, and wherein the primary coil is positioned in the cavity.

5. The rotary transformer of claim 4 wherein the rotating PCB extends into the cavity of the core.

6. The rotary transformer of claim 3 wherein the diode holder includes a main body with at least one tab extending from the main body, wherein the at least one tab is the at least one target, and wherein a plurality of diodes are positioned on the main body.

7. The rotary transformer of claim 6 wherein the main body of the diode holder is cylindrical and the plurality of diodes are embedded in recesses in a face of the main body.

8. The rotary transformer of claim 6 wherein the at least one tab of the diode holder is positioned axially across an airgap from the at least one sensing coil of the inductive position sensor.

9. The rotary transformer of claim 6 wherein the at least one tab is comprised of an electrically conductive metal.

10. The rotary transformer of claim 3 wherein the diode holder is radially inward from the primary coil and the at least one target is arranged axially between the stationary PCB and the rotating PCB.

11. The rotary transformer of claim 3 wherein the primary coil is comprised on Litz wire and the secondary coil is comprised of traces on the rotating PCB.

12. The rotary transformer of claim 3 wherein the diode holder is connected to a rotor coupling with the rotating PCB positioned between the diode holder and the rotor coupling.

13. A rotary transformer comprising:
a stationary portion including a transformer housing with a core arranged within the transformer housing and a primary coil arranged within the core, the stationary portion further including an excitation coil of an inductive position sensor and at least one sensing coil of the inductive position sensor arranged on a stationary mount; and
a rotating portion including a diode holder connected to a rotating coil mount, wherein a secondary coil of the rotary transformer is arranged on the rotating coil mount and positioned within the core, and wherein at least one target of the inductive position sensor is positioned on the diode holder.

14. The rotary transformer of claim 13 wherein the stationary mount is a stationary printed circuit board (PCB) and the rotating coil mount is a rotating PCB.

15. The rotary transformer of claim 13 wherein the diode holder includes a main body with at least one tab extending from the main body, wherein the at least one tab is the at least one target, and wherein a plurality of diodes are positioned on the main body.

16. The rotary transformer of claim 15 wherein the main body of the diode holder is cylindrical and the plurality of diodes are embedded in cavities in the main body.

17. The rotary transformer of claim 15 wherein the at least one tab of the diode holder is positioned axially across an airgap from the at least one sensing coil of the inductive position sensor.

18. The rotary transformer of claim 17 wherein the main body of the diode holder is positioned radially inward from the primary coil.

19. A wound rotor synchronous machine (WRSM) comprising:
a stator including a stator core with stator windings positioned on the stator core;
a rotor positioned within the stator, the rotor including a rotor core with rotor windings positioned on the rotor core;
a rotor coupling connected to the rotor; and
a rotary transformer comprising:
a stationary portion including a primary coil, an excitation coil of an inductive position sensor, and at least one sensing coil of the inductive position sensor; and
a rotating portion connected to the rotor coupling, the rotating portion including a diode holder connected to a rotating coil mount, wherein the diode holder includes at least one target of the inductive position sensor and wherein a secondary coil is arranged on the rotating coil mount.

20. The wound rotor synchronous machine of claim 19, wherein the excitation coil and the at least one sensing coil of the inductive position sensor are positioned on a stationary printed circuit board on the stationary portion of the rotary transformer, wherein the diode holder includes a cylindrical main body with at least one tab extending radially outward from the main body, wherein a plurality of diodes are positioned on the main body, and wherein the at least one tab is the at least one target of the inductive position sensor.
